(19) United States
(12) Patent Application Publication
(10) Pub. No.: US 2011/0231151 A1
(43) Pub. Date: Sep. 22, 2011

(54) DISTANCE DETECTION APPARATUS, AND METHOD USABLE FOR THE SAME

(75) Inventor: Yoshihiko Takahashi, Aichi (JP)

(73) Assignee: TOYOTA JIDOSHA KABUSHIKI KAISHA, Toyota-shi (JP)

(21) Appl. No.: 12/671,040

(22) PCT Filed: Apr. 16, 2009
(86) PCT No.: PCT/JP09/01756

§ 371 Date: Jan. 28, 2010

(51) Int. Cl. G01S 17/10

(52) U.S. Cl. 702/159

(57) ABSTRACT

A distance detection apparatus for preventing the accuracy of a distance to be detected from decreasing due to a signal-to-noise ratio of an accumulated electric charge is provided. The distance detection apparatus comprises a radiation section for radiating light; a conversion section for converting light radiated and then reflected at a target object into an electric charge by each of light receiving elements arranged in a lattice; a luminance conversion section for converting the electric charge converted by each of the light receiving elements into a luminance value corresponding to the respective light receiving element; a calculation section for calculating a distance corresponding to each of the light receiving elements based on the electric charge converted by the respective light receiving element; a filter processing section for performing filter processing on the distance corresponding to each of the light receiving element based on the luminance value corresponding to the respective light receiving element; and a generation section for generating distance information representing the distance filter-processed by the filter processing section.

### TECHNICAL FIELD

The present invention relates to a distance image detection apparatus, and more specifically to a distance image detection apparatus for generating a distance image based on reflected light received by a light receiving element.

### BACKGROUND ART

Conventionally, various optical distance measurement apparatuses have been developed for measuring a relative distance to a target object based on the time required for light emitted from a light emitting element and then reflected by the target object to be received by a light receiving element. An example of such an optical distance measurement apparatus is described in Patent Literature 1 (hereinafter, referred to as the “conventional art”).

According to the conventional art, two accumulation elements are used for preventing the accuracy of the measurement result on a target object from decreasing due to background light being received by a light receiving element together with reflected light reflected by the target object. In more detail, according to the conventional art, an electric charge obtained by converting the reflected light by the receiving element and an electric charge obtained by converting the background light by the receiving element are accumulated in two accumulation elements, respectively. With the conventional art, the accumulation of the electric charges in the two accumulation elements is performed as follows. An electric charge converted by the light receiving element while light is emitted from a light emitting element is accumulated in a first accumulation element, and an electric charge converted by the light receiving element while light is not emitted from the light emitting element is accumulated in a second accumulation element. The electric charge converted by the light receiving element while light is emitted from the light emitting element corresponds to an electric charge obtained by converting the reflected light and the background light by the light receiving element. By contrast, the electric charge converted by the light receiving element while light is not emitted from the light emitting element corresponds to an electric charge obtained by converting only the background light by the light receiving element.

With the conventional art, a difference between the electric charge accumulated in the first accumulation element and the electric charge accumulated in the second accumulation element is accumulated. Thus, an electric charge deprived of the influence of the background light, as a result of subtracting the electric charge obtained by converting only the background light by the light receiving element from the electric charge obtained by converting the reflected light and the background light by the light receiving element, is accumulated. Also with the conventional art, the electric charge deprived of the influence of the background light is accumulated a plurality of times, and thus an electric charge sufficient to calculate the distance is accumulated.

Patent Literature 1: Japanese Laid-Open Patent Publication No. 2007-132848

### DISCLOSURE OF THE INVENTION

### Problems to be Solved by the Invention

However, the conventional art has the following problems. Target objects, a relative distance to which can be measured by the above-described conventional art, include target objects having surfaces of various optical characteristics, for example, a target object having a surface of a low reflectance, a target object having a surface of a high reflectance, and the like. When relative distances to target objects having such surfaces of different optical characteristics are measured, the following may occasionally occur. Even where the target objects are located at the same relative distance, a signal-to-noise ratio of the electric charge obtained by receiving and converting the reflected light by the light receiving element is increased or decreased for the reason that, for example, the intensity of the reflected light is different depending on the target object. As a result, an electric charge of an excessively low signal-to-noise ratio may be occasionally accumulated. A relative distance calculated using an electric charge of such an excessively low signal-to-noise ratio is low in accuracy.

Recently, the following distance detection apparatus has been conceived. Light receiving elements as described in the conventional art are arranged in a lattice, and pixels are arranged in a lattice in correspondence with the light receiving elements. An electric charge obtained by converting the reflected light by each light receiving element is converted into a luminance value of the corresponding pixel. An image represented by the pixel having such a converted luminance value is generated as a distance image. In the case where target objects having surfaces of various optical characteristics are present in an image-taking zone for which such a distance detection apparatus can generate a distance image, a relative distance calculated using an electric charge of an excessively low signal-to-noise ratio as described above is low in accuracy.

Therefore, the present invention has an object of providing a distance detection apparatus for preventing the accuracy of a distance to be detected from decreasing due to a signal-to-noise ratio of an accumulated electric charge.

### Solution to the Problems

To achieve the above objects, the present invention has the following aspects.

A first invention comprises a radiation section for radiating light; a conversion section for converting light radiated and then reflected at a target object into an electric charge by each of light receiving elements arranged in a lattice; a luminance conversion section for converting the electric charge converted by each of the light receiving elements into a luminance value corresponding to the respective light receiving element; a calculation section for calculating a distance corresponding to each of the light receiving elements based on the electric charge converted by the respective light receiving element; a filter processing section for performing filter processing on the distance corresponding to each of the light receiving element based on the luminance value corresponding to the respective light receiving element; and a generation section for generating distance information representing the distance filter-processed by the filter processing section.

A second invention is dependent from the first invention described above. The filter processing section performs the filter processing based on the luminance value corresponding to each of the light receiving elements, using the distance calculated in the past in correspondence with the respective light receiving element.

A third invention is dependent from the second invention described above. The filter processing section includes a setting section for specifying the light receiving element corresponding to the luminance which is equal to or higher than a predefined threshold value among the light receiving elements corresponding to the luminance values converted by the luminance conversion section; and a processing section for performing the filter processing such that the distance calculated in correspondence with the light receiving element specified by the setting section is reflected at a relatively high degree as compared with the distance calculated in the past in correspondence with the light receiving element.

A fourth invention is dependent from the second invention described above. The filter processing section includes a setting section for specifying the light receiving element corresponding to the luminance which is lower than a predefined threshold value among the light receiving elements corresponding to the luminance values converted by the luminance conversion section; and a processing section for performing the filter processing such that the distance calculated in correspondence with the light receiving element specified by the setting section is reflected at a relatively low degree as compared with the distance calculated in the past in correspondence with the light receiving element.

A fifth invention is dependent from the second invention described above. The filter processing section includes a dispersion calculation section for calculating a dispersion value of the luminance values, corresponding to each of the light receiving elements, converted by the luminance conversion section throughout a predefined period; a setting section for specifying a dispersion value of the luminance values which is equal to or lower than a predefined threshold value among the light receiving elements each corresponding to the dispersion value of the luminance values calculated by the dispersion calculation section; and a processing section for performing the filter processing such that the distance calculated in correspondence with the light receiving element specified by the setting section is reflected at a relatively high degree as compared with the distance calculated in the past in correspondence with the light receiving element.

A sixth invention is dependent from the second invention described above. The filter processing section includes a dispersion calculation section for calculating a dispersion value of the luminance values, corresponding to each of the light receiving elements, converted by the luminance conversion section throughout a predefined period; a setting section for specifying a dispersion value of the luminance values which exceeds a predefined threshold value among the light receiving elements each corresponding to the dispersion value of the luminance values calculated by the dispersion calculation section; and a processing section for performing the filter processing such that the distance calculated in correspondence with the light receiving element specified by the setting section is reflected at a relatively low degree as compared with the distance calculated in the past in correspondence with the light receiving element.

A seventh invention comprises a radiation step of radiating light; a conversion step of converting light radiated and then reflected at a target object into an electric charge by each of light receiving elements arranged in a lattice; a luminance conversion step of converting the electric charge converted by each of the light receiving elements into a luminance value corresponding to the respective light receiving element; a calculation step of calculating a distance corresponding to each of the light receiving elements based on the electric charge converted by the respective light receiving element; a filter processing step of performing filter processing on the distance corresponding to each of the light receiving element based on the luminance value corresponding to the respective light receiving element; and a generation step of generating distance information representing the distance filter-processed by the filter processing section.

### Effect of the Invention

According to the present invention, a distance detection apparatus for preventing the accuracy of a distance to be detected from decreasing due to a signal-to-noise ratio of an accumulated electric charge can be provided.

### BRIEF DESCRIPTION OF THE DRAWINGS

FIG. 1 is a block diagram showing a schematic structure of a distance detection apparatus according to the present invention.

FIG. 2 is a functional block diagram showing more detailed functional structural elements of a control and operation section in a first embodiment.

FIG. 3 is a functional block diagram showing more detailed functional structural elements of a filter processing section in the first embodiment.

FIG. 4 is a functional block diagram showing more detailed functional structural elements of a control and operation section in a third modification of the first embodiment.

FIG. 5 is a functional block diagram showing more detailed functional structural elements of a control and operation section in a fourth modification of the first embodiment.

FIG. 6 is a functional block diagram showing more detailed functional structural elements of a control and operation section in a second embodiment.

FIG. 7A shows an example of an attaching position of a distance detection apparatus in the second embodiment to a vehicle.

FIG. 7B shows an example of an attaching position of the distance detection apparatus in the second embodiment to the vehicle.

FIG. 8 illustrates a technique for calculating a three-dimensional position coordinate of a reflection point.

FIG. 9 illustrates a technique for distinguishing a reflection point on a surface of a target object from a reflection point on a road surface.

### DESCRIPTION OF THE REFERENCE CHARACTERS

1, 2 distance detection apparatus

101 radiation section

102 conversion section

103 control and operation section

1031 control section

1032 calculation section

1033 luminance conversion section

1034 filter processing section

1035 storage section

1036 generation section

1037 distance dispersion calculation section

1038 distance expected value calculation section

1039 target object specification section

### BEST MODE FOR CARRYING OUT THE INVENTION

### First Embodiment

FIG. 1 is a block diagram showing a schematic structure of a distance detection apparatus 1 in this embodiment. The distance detection apparatus 1 in this embodiment includes a radiation section 101, a conversion section 102 and a control and operation section 103.

The radiation section 101 typically emits light having a wavelength of an infrared region (hereinafter, referred to as “infrared light”) for a time period instructed by the control and operation section 103. The radiation section 101 may radiate the infrared light with any technique as long as the conversion section 102 described later can receive reflected light from a measurement zone. According to a more specific example of the technique used by the radiation section 101, infrared light is radiated to an arbitrary area by controlling the reflection angle at which laser light having a wavelength in the infrared region is reflected by a reflection plate or the curvature of a diffusion plate used for diffusing such light. An example of a light source of light having a wavelength in the infrared region is a near-infrared LED (Light Emitting Diode).

The conversion section 102 is typically an electronic component including a substrate having a plurality of light receiving elements arranged in a lattice thereon. The conversion section 102 receives, by the light receiving elements, the infrared light radiated by the radiation section 101 and reflected by a target object throughout a time period instructed by the control and operation section 103 described later. The reflected light received by each light receiving element of the conversion section 102 is converted into an electric charge corresponding to an intensity thereof. The electric charge converted by each light receiving element is accumulated in an accumulation section provided on the substrate in correspondence with the respective light receiving element. The light receiving elements of the conversion section 102 may each be embodied by a CMOS (Complementary Metal Oxide Semiconductor) element, a CCD (Charge Coupled Device) element or the like.

The control and operation section 103 converts the electric charge accumulated in correspondence with each light receiving element into a luminance corresponding to the respective light receiving element. Based on the electric charge accumulated in correspondence with each light emitting element, the control and operation section 103 calculates a distance to a reflection point, on a surface of the target object, at which the reflected light received by the respective light receiving element was reflected, the distance being calculated in correspondence with the respective light receiving element. Based on the luminance converted in correspondence with each light receiving element, the control and operation section 103 performs filter processing on the distance calculated in correspondence with the respective light receiving element. After performing the filter processing on the distance calculated in correspondence with each light receiving element, the control and operation section 103 generates information representing the filter-processed distance.

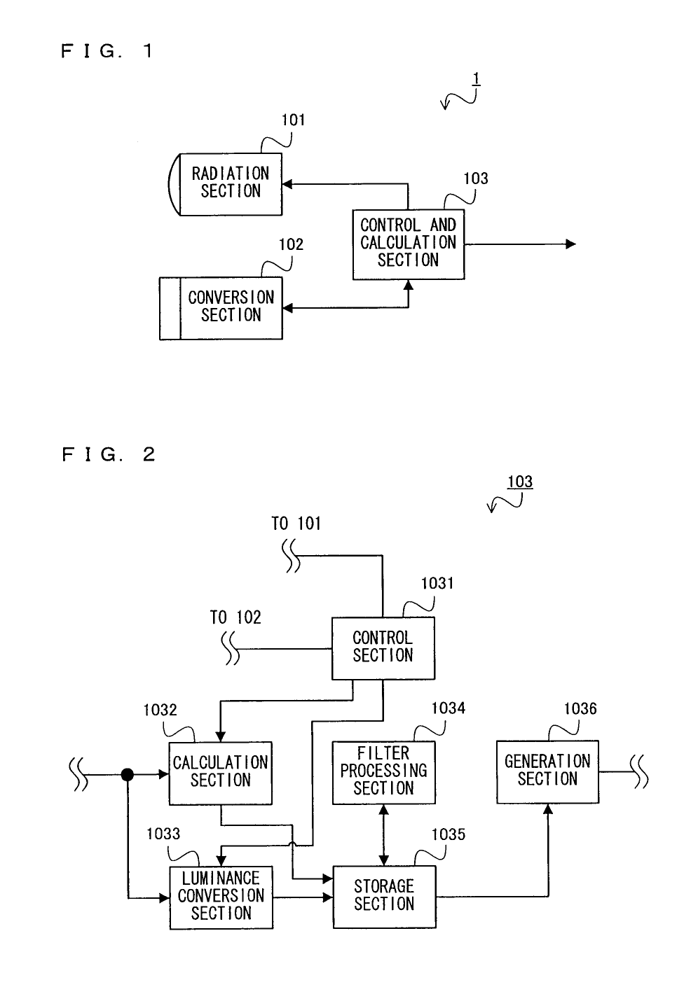

The control and operation section 103 in this embodiment will be described in more detail. FIG. 2 is a functional block diagram showing more detailed functional structural elements of the control and operation section 103 in this embodiment. The control and operation section 103 in this embodiment includes a control section 1031, a calculation section 1032, a luminance conversion section 1033, a filter processing section 1034, a storage section 1035, and a generation section 1036.

The control section 1031 instructs the radiation section 101 to radiate infrared light throughout a predefined radiation period, and also instructs the conversion section 102 to receive reflected light throughout a predefined light receiving period. Owing to this, an electric charge in accordance with the time period required for the reflected light reflected at the reflection point on the surface of the target object to reach each light receiving element is accumulated in the accumulation section provided in correspondence with the respective light receiving element located in the conversion section 102.

When the electric charge is accumulated in the accumulation section provided in correspondence with each light receiving element, the calculation section 1032 and the luminance conversion section 1033 described below detect an amount of the accumulated electric charge in correspondence with the respective light receiving element. When the amount of the accumulated electric charge is detected, the conversion section 102 performs a reset by, for example, causing the accumulation sections to release the electric charge amounts detected in correspondence with all the light receiving elements, and again accumulates an electric charge in conformity with an instruction issued from the control section 1031.

When accumulated in each accumulation section provided in the conversion section 102, the electric charge may be accumulated such that the distance calculated by the calculation section 1032 described later is not influenced by external disturbing light.

More specifically, the control section 1031 first instructs the conversion section 102 to receive light by each receiving element throughout a predefined first light receiving period. An electric charge obtained converted from light received by each light receiving element throughout the first light receiving period is accumulated in the accumulation section, provided in correspondence with the respective light receiving elements, as an electric charge in accordance with external disturbing light except for the reflected light from the infrared light radiated from the radiation section 101. When the first light receiving period is over, the control section 1031 instructs the radiation section 101 to radiate the infrared light throughout the above-described radiation period and also instructs the conversion section 102 to receive light throughout a predefined second light receiving period. An electric charge converted from the light received by each receiving element throughout the second light receiving period is accumulated in the accumulation section provided in correspondence with the respective light receiving element, as an electric charge in accordance with the reflected infrared light and the external disturbing light.

Upon accumulating the electric charges in each accumulation section in the first light receiving period and the second light receiving period, the conversion section 102 leaves only the difference between the electric charges, accumulated in the respective accumulation section in the two light receiving periods, to be accumulated in the accumulation section provided in correspondence with each light receiving element. As a result, in the accumulation section provided in correspondence with each light receiving element, an electric charge obtained by subtracting the electric charge accumulated in accordance with the external disturbing light throughout the first light receiving period from the electric charge accumulated in accordance with both of the reflected infrared light and the external disturbing light throughout the second light receiving period, namely, the electric charge in accordance with only the reflected infrared light is accumulated. In order to leave only the electric charge of the difference in correspondence with each light receiving element, at least two accumulation sections, i.e., a first accumulation section for accumulating the electric charge in the first light receiving period and a second accumulation section for accumulating the electric charge in the second light receiving period may be provided in the conversion section 102 in correspondence with each light receiving element. In this case, the difference between the electric charge accumulated in the second accumulation section and the electric charge accumulated in the first accumulation section provided for the same light receiving element as the second accumulation section may be accumulated in either one of the accumulation sections or may be accumulated in a third accumulation section provided in correspondence with each light receiving element. Such accumulation is performed in correspondence with each light receiving element. In this manner, the electric charge of the difference can be accumulated in correspondence with each light receiving element.

When the electric charge is accumulated in the accumulation section provided in correspondence with each light receiving element of the conversion section 102, the calculation section 1032 detects an amount of the accumulated electric charge in correspondence with the respective light receiving element and stores the amount on the storage section 1035. Based on the electric charge amount stored in correspondence with each light receiving element, the calculation 1032 calculates a distance corresponding to the respective light receiving element by an arbitrary known technique and additionally stores the distance on the storage section 1035 in correspondence with the respective light receiving element. The distance calculated by the calculation section 1035 is the distance between the reflection point on the surface of the target object at which the reflected light received by the respective light receiving element was reflected and such a light receiving element. The expression “storing on the storage section 1035 in correspondence with the respective light receiving element” means, more precisely, storing in correspondence with an identifier for identifying the respective light receiving element. In the description of the present invention, however, the expression “storing in correspondence with the light receiving element” is used for the convenience of description.

When the electric charge is accumulated in the accumulation section provided in correspondence with each light receiving element of the conversion section 102, the luminance conversion section 1033 detects the amount of the accumulated electric charge in correspondence with the respective light receiving element, and converts the detected electric charge amount into a luminance value at which the detected electric charge amount is displayed in an image. Such conversion is performed in correspondence with each light receiving element. Upon converting the detected electric charge amount into a luminance value in correspondence with each light receiving element, the luminance conversion section 1033 additionally stores the luminance value in correspondence with the respective light receiving element on the storage section 1035, which already has, in storage, the distance calculated by the calculation section 1032 in correspondence with each light receiving element.

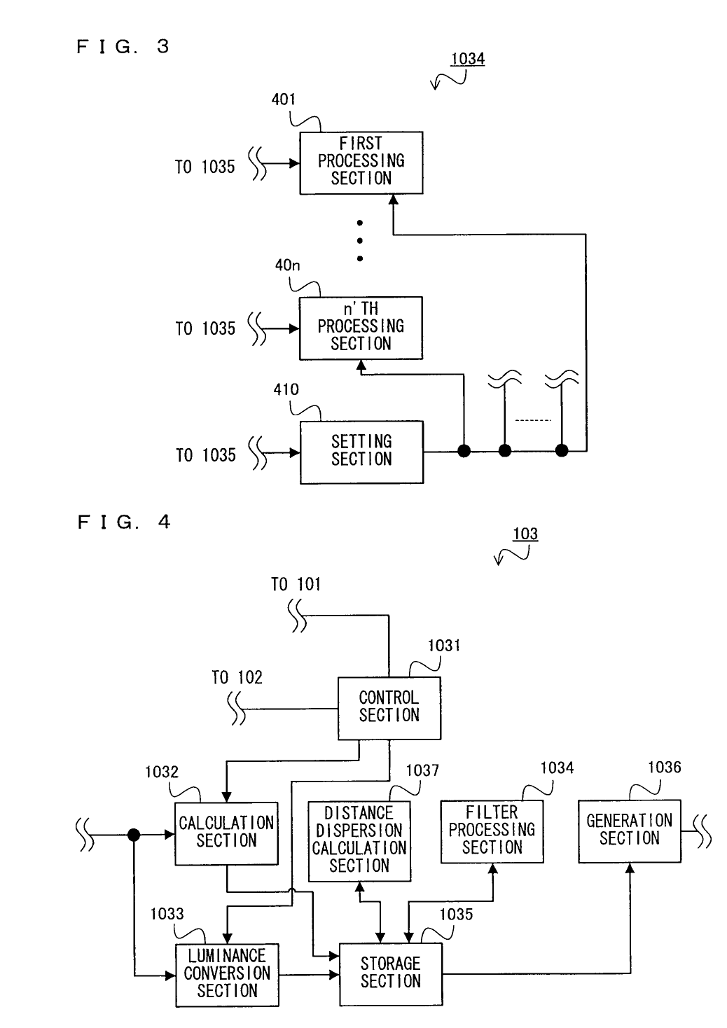

When the distance and the luminance value corresponding to each light receiving element are stored on the storage section 1035, the filter processing section 1034 performs filter processing on the distance calculated in correspondence with each light receiving element based on the luminance converted in correspondence with the respective light receiving element. The filter processing section 1034 will be described in more detail with reference to FIG. 3.

FIG. 3 is a functional block diagram showing more detailed functional structural elements of the filter processing section 1034 in this embodiment. The conversion section 102 in this embodiment includes n pieces of light receiving elements from a first light receiving element through an n'th light receiving element, and the filter processing section 1034 includes a first processing section 401 through an n'th processing section 40n respectively in correspondence with the first light receiving element through the n'th light receiving element, and a setting section 410.

When the luminance conversion section 1033 stores the luminance value converted in correspondence with each light receiving element on the storage section 1035, the setting section reads the stored luminance value in correspondence with each light receiving element and compares the read luminance value against a threshold value. In more detail, the setting section 410 has, in storage, a first threshold value and a second threshold value defined to be smaller than the first threshold value in advance. When the luminance value converted in correspondence with each light receiving element is stored on the storage section 1035 by the luminance conversion section 1033, the setting section 410 first specifies a light receiving element corresponding to a luminance value which is equal to or higher than the first threshold value (hereinafter, such a luminance value will be referred to as the “high luminance value”). Then, the setting section 410 specifies a light receiving element corresponding to a luminance value which is lower than the first threshold value and equal to or higher than the second threshold value (hereinafter, such a luminance value will be referred to as the “medium luminance value”). Then, the setting section 410 specifies a light receiving element corresponding to a luminance value which is lower than the second threshold value (hereinafter, such a luminance value will be referred to as the “low luminance value”).

Now, the first threshold value and the second threshold value will be described. As described above, the calculation section 1032 in this embodiment calculates the distance based on the amount of the electric charge accumulated in correspondence with each light receiving element provided in the conversion section 102. However, the accuracy of the distance calculated by the calculation section 1032 varies in accordance with the signal-to-noise ratio at the time when the calculation section 1032 detects the amount of the electric charge accumulated in correspondence with each light receiving element. More specifically, when the signal-to-noise ratio of the electric charge amount detected by the calculation section 1032 is relatively high, the accuracy of the calculated distance is high. By contrast, when the signal-to-noise ratio of the electric charge amount detected by the calculation section 1032 is relatively low, the accuracy of the calculated distance is low. Furthermore, when the signal-to-noise ratio of the electric charge amount detected by the calculation section 1032 is excessively low, the accuracy of the calculated distance is excessively low and so is inappropriate as the distance represented by the information generated by the generation section 1036 described later.

The “signal-to-noise ratio at the time when the amount of the electric charge accumulated in correspondence with each light receiving element provided in the conversion section 102 is detected” is a ratio of the amount of the accumulated electric charge with respect to the dark current generated inside the conversion section 102, or in the conversion section 102 or inside the calculation section 1032, or the inner noise of the distance detection apparatus 1.

The signal-to-noise ratio at the time when the amount of the electric charge accumulated in correspondence with each light receiving element provided in the conversion section 102 is detected by the calculation section 1032 is in proportion to the luminance value obtained by converting the respective accumulated electric charge amount by the luminance conversion section 1033. More specifically, the signal-to-noise ratio at the time when the calculation section 1032 detects an electric charge amount which has been converged into a high luminance value described above, which is relatively high, by the luminance conversion section 1033 is relatively high. The signal-to-noise ratio at the time when the calculation section 1032 detects an electric charge amount which has been converged into a medium luminance value described above, which is relatively low, by the luminance conversion section 1033 is relatively low. The signal-to-noise ratio at the time when the calculation section 1032 detects an electric charge amount which has been converged into a low luminance value described above, which is excessively low, by the luminance conversion section 1033 is excessively low.

Namely, the distance calculated in correspondence with a light receiving element corresponding to a high luminance value is a distance calculated at a relatively high accuracy, and the distance calculated in correspondence with a light receiving element corresponding to a medium luminance value is a distance calculated at a relatively low accuracy. By specifying a light receiving element corresponding to a high luminance value which is equal to or higher than the first threshold value, the setting section 410 can specify a light receiving element corresponding to a distance calculated at a relatively high accuracy. By specifying a light receiving element corresponding to a medium luminance value which is lower than the first threshold value and equal to or higher than the second threshold value, the setting section 410 can specify a light receiving element corresponding to a distance calculated at a relatively low accuracy. By specifying a light receiving element corresponding to a low luminance value which is lower than the second threshold value, the setting section 410 can specify a light receiving element corresponding to a distance calculated at an excessively low accuracy.

Upon specifying the light receiving elements respectively corresponding to the high luminance value, the medium luminance value and the low luminance value using the first threshold value, the second threshold value and the luminance value of each light receiving element, the setting section 410 causes the first processing section 401 through the n'th processing section 40n to perform filter processing in accordance with the high luminance value, the medium luminance value and the low luminance value, respectively.

In more detail, upon specifying the light receiving element corresponding to the high luminance value, the setting section 410 instructs a processing section, among the first processing section 401 through the n'th processing section 40n, corresponding to the specified light receiving element to perform filter processing in accordance with the high luminance value. Upon specifying the light receiving element corresponding to the medium luminance value, the setting section 410 instructs a processing section, among the first processing section 401 through the n'th processing section 40n, corresponding to the specified light receiving element to perform filter processing in accordance with the medium luminance value. Upon specifying the light receiving element corresponding to the low luminance value, the setting section 410 instructs a processing section, among the first processing section 401 through the n'th processing section 40n, corresponding to the specified light receiving element to perform filter processing in accordance with the low luminance value.

Now, first, the filter processing performed by the processing section instructed by the setting section 410 to perform the filter processing in accordance with the high luminance value (hereinafter, such a processing section will be referred to as the “high luminance processing section”) and the filter processing performed by the processing section instructed by the setting section 410 to perform the filter processing in accordance with the medium luminance value (hereinafter, such a processing section will be referred to as the “medium luminance processing section”), among the first processing section 401 through the n'th processing section 40n in this embodiment, will be described. It is assumed that the high luminance processing section and the medium luminance processing section in this embodiment each perform Kalman filter processing as an example of filter processing. The following expression (1) is an example of a mathematical expression representing the Kalman filter processing.

x=kz+(1−k)y (1)

In the expression, x is the latest distance which is filter-processed, namely, the distance smoothed by the Kalman filter processing (hereinafter, referred to as the “latest smoothed distance”). y is the distance estimated using the distances obtained by the Kalman filter processing performed up to the immediately previous time (hereinafter, referred to as the “estimated distance”). z is the latest distance calculated by the calculation section 1032 (hereinafter, referred to as the “latest calculated distance”). k is the Kalman constant. Expression (1) indicates that the degree at which the latest calculated distance is reflected on the latest smoothed distance, and the degree at which the estimated distance is reflected on the latest smoothed distance, increase or decrease in a contrary relationship to each other in accordance with the magnitude of the Kalman constant k. More specifically, when the operation of expression (1) is performed with a relatively large Kalman constant k, the latest calculated distance is reflected on the latest smoothed distance at a relatively high degree. When the operation of expression (1) is performed with a relatively small Kalman constant k, the estimated distance is reflected on the latest smoothed distance at a relatively high degree. The Kalman constant k is defined by the following expression (2).

$$k = \frac{P}{P + R} \qquad ( 2 )$$

In the expression, P is the estimation error covariance, and R is the observation error variance, both in the Kalman filter theory. Expression (2) indicates that the magnitude of the Kalman constant k can be determined by the magnitude of the observation error covariance R. More specifically, a Kalman constant k which is determined by performing the operation of expression (2) with a relatively large observation error covariance R is relatively small. A Kalman constant k which is determined by performing the operation of expression (2) with a relatively small observation error covariance R is relatively large. When the high luminance processing section and the medium luminance processing section perform the Kalman filter processing, the observation error covariance R is the filter coefficient.

As described above, the latest calculated distance which is filter-processed by the high luminance processing section is a distance calculated at a relatively high accuracy. As the distance having a relatively high accuracy is reflected on the latest smoothed distance at a relatively high degree, the accuracy of the latest smoothed distance is relatively high. Namely, the high luminance processing section can estimate the latest smoothed distance having a relatively high accuracy by reflecting the latest calculated distance having a relatively high accuracy on the latest smoothed distance at a relatively high degree. In order to reflect the latest calculated distance having a relatively high accuracy on the latest smoothed distance at a relatively high degree, as is clear from expression (1), the Kalman constant k needs to be relatively large. In order to make the Kalman constant k relatively large, as is clear from expression (2), the Kalman constant k needs to be calculated using a relatively small observation error covariance R. Accordingly, the processing section, among the first processing section 401 through the n'th processing section 40n, which is instructed by the setting section 410 to perform the filter processing as the high luminance processing section reads an observation error covariance R predefined to be relatively small from the storage section 1035 such that a relatively large Kalman constant k can be calculated.

By contrast, the latest calculated distance which is filter-processed by the medium luminance processing section is a distance calculated at a relatively low accuracy. As the distance having a relatively low accuracy is reflected on the latest smoothed distance at a relatively low degree, the accuracy of the latest smoothed distance is relatively high. Namely, the medium luminance processing section can estimate the latest smoothed distance having a relatively high accuracy by reflecting the latest calculated distance having a relatively low accuracy on the latest smoothed distance at a relatively low degree. In order to reflect the latest calculated distance having a relatively low accuracy on the latest smoothed distance at a relatively low degree, as is clear from expression (1), the Kalman constant k needs to be relatively small. In order to make the Kalman constant k relatively small, as is clear from expression (2), the Kalman constant k needs to be calculated using a relatively large observation error covariance R. Accordingly, the processing section, among the first processing section 401 through the n'th processing section 40n, which is instructed by the setting section 410 to perform the filter processing as the medium luminance processing section reads an observation error covariance R predefined to be relatively large from the storage section 1035 such that a relatively small Kalman constant k can be calculated.

Upon reading the observation error covariance R from the storage section 1035, the high luminance processing section and the medium luminance processing section each calculate the Kalman constant k using the read observation error covariance R and perform Kalman filter processing using the calculated Kalman constant to calculate the latest smoothed distance. Upon calculating the latest smoothed distance, the high luminance processing section and the medium luminance processing section each store the calculated latest smoothed distance on the storage section 1035 in correspondence with the light receiving element corresponding to the respective processing section.

In this embodiment, a data table representing a predefined observation error covariance R in correspondence with each of the high luminance value and the medium luminance value may be stored on the storage section 1035 in advance. In this case, the high luminance processing section and the medium luminance processing section, when being instructed by the setting section 410 to perform the filter processing as the high luminance processing section and the medium luminance processing section respectively, read an appropriate observation error covariance R from the data table stored on the storage section 1035 and perform the filter processing.

Now, the filter processing performed by the processing section instructed by the setting section 410 to perform the filter processing in accordance with the low luminance value (hereinafter, such a processing section will be referred to as the “low luminance processing section”), among the first processing section 401 through the n'th processing sections 40n in this embodiment, will be described. The low luminance processing section in this embodiment performs, as optimal filter processing for a distance calculated at an excessively low accuracy, filter processing of converting the calculated distance into the same distance as the filter-processed distance corresponding to a light receiving element in the vicinity of the light receiving element corresponding to the calculated distance and smoothing the distance obtained by the conversion (hereinafter, this filter processing will be referred to as the “conversion processing”).

As described above, the latest calculated distance which is filter-processed by the low luminance processing section is a distance calculated at an excessively low accuracy. Even if such a distance is filter-processed in the same manner as by the high luminance processing section or the medium luminance processing section, the post-filter processing distance is inappropriate as a distance represented by the information generated by the generation section 1036 described later. Accordingly, the low luminance processing section converts the distance corresponding to the light receiving element corresponding to the low luminance processing section into the same distance as the filter-processed distance corresponding to a light receiving element in the vicinity of the above-mentioned light receiving element corresponding to the low luminance processing section (in this embodiment, such filter processing is, for example, the filter processing performed by the high luminance processing section or the medium luminance processing section). In this manner, the distance corresponding to the light receiving element corresponding to the low luminance processing section can be smoothed to a distance between the reflection point of the reflected light received by the light receiving element in the vicinity of the above-mentioned light receiving element corresponding to the low luminance processing section, namely, a distance close to an actual distance.

Upon performing the conversion processing, the low luminance processing section stores the converted distance on the storage section 1035 in correspondence with the light receiving element corresponding to the processing section. The low luminance processing section may convert the distance corresponding to the light receiving element corresponding to the low luminance processing section into a signal indicating that the distance cannot be detected (for example, a signal representing zero). The above is a description of the filter processing section 1034.

The storage section 1035 is typically a ROM (Read Only Memory) or a RAM (Random Access Memory), and is caused to store various numerical values by the calculation section 1032, the luminance conversion section 1033 and the filter processing section 1034 as described above.

When the distances corresponding to all the light receiving elements provided in the conversion section 102 are filter-processed by the filter processing section 1034, the generation section 1036 reads the post-filter processing distance stored by the filter processing section 1034 in correspondence with each light receiving element and generates distance information representing such a distance in correspondence with the light receiving element.

The above is a description of the distance detection apparatus 1 in this embodiment. According to the distance detection apparatus 1 in this embodiment, the latest calculated distance calculated in correspondence with each light receiving element is filter-processed with a filter coefficient in accordance with the luminance value converted in correspondence with the respective light receiving element. Therefore, the accuracy of a distance to be detected can be prevented from decreasing in accordance with the signal-to-noise ratio of the accumulated electric charge. Especially, the filter processing section 1034 in this embodiment performs the Kalman filter processing by the high luminance processing section and the medium luminance processing section with a Kalman constant k in accordance with the luminance value in correspondence with each light receiving element. Therefore, the distance can be detected by estimating a distance close to an actual distance.

In this embodiment, the high luminance processing section and the medium luminance processing section, after being instructed by the setting section 410 to perform the filter processing in accordance with the high luminance value and the medium luminance value respectively, read the observation error covariance R in accordance with the respective filter processing from the storage section 1035. Alternatively, in this embodiment, the setting section 410, when issuing an instruction to perform the filter processing in accordance with the high luminance value and the medium luminance value respectively, may read the observation error covariance R in accordance with the respective filter processing from the storage section 1035 and allow the high luminance processing section and the medium luminance processing section to acquire the observation error covariance R.

In this embodiment, the setting section 410 classifies the luminance values converted by the luminance conversion section 1033 into the high luminance value, the medium luminance value and the low luminance value using two threshold values, i.e., the first threshold value and the second threshold value. Alternatively, the setting section 410 in this embodiment may classify the luminance values converted by the luminance conversion section 1033 using only one threshold value. In this case, the setting section 410 may determine that a luminance value equal to or higher than the one threshold value as the high luminance value and instruct a processing section, among the first processing section 401 through the n'th processing section 40n, corresponding to the light receiving element corresponding to the high luminance value to perform the filter processing in accordance with the high luminance value. In this case, the setting section 410 may determine that a luminance value lower than the one threshold value as the medium luminance value and instruct a processing section, among the first processing section 401 through the n'th processing section 40n, corresponding to the light receiving element corresponding to the medium luminance value to perform the filter processing in accordance with the medium luminance value.

In this embodiment, the setting section 410 classifies the luminance values converted by the luminance conversion section 1033 using two threshold values, i.e., the first threshold value and the second threshold value. Alternatively, the setting section 410 may classify the luminance values converted by the luminance conversion section 1033 using three or more threshold values. The setting section 410 may instruct each of the first processing section 401 through the n'th processing section 40n to perform the filter processing using a filter coefficient in accordance with a luminance value classified with the three or more threshold values. In this case, the setting section 410 needs to have, in storage, preset filter coefficients (in this embodiment, values of observation error covariance R) of the number corresponding to the number of the classes of luminance values into which the setting section 410 classifies the luminance values. In this case, the first processing section 401 through the n'th processing section 40n perform the filter processing as processing sections for performing the filter processing using a filter coefficient in accordance with the luminance value obtained as a result of the classification, not only as the three processing sections, i.e., the high luminance processing section, the medium luminance processing section and the low luminance processing section.

In this embodiment, the high luminance processing section and the medium luminance processing section each calculate the latest smoothed distance as a result of performing the Kalman filter processing based only on the distances (the latest calculated distance and the estimated distance). Alternatively, the high luminance processing section and the medium luminance processing section may each calculate the latest smoothed distance by performing the Kalman filter processing using the distances and the velocity as state variables. In this case, the high luminance processing section and the medium luminance processing section may each use, as the velocity, the difference between the latest calculated distance and the distance calculated in the past both corresponding to the respective light receiving element.

In this embodiment, the high luminance processing section and the medium luminance processing section each perform the Kalman filter processing only on the latest calculated distance. Alternatively, the high luminance processing section and the medium luminance processing section may each perform the Kalman filter processing on the latest calculated velocity to calculate the latest smoothed acceleration in the same manner as performing the Kalman filter processing on the latest calculated distance. In this case, high luminance processing section and the medium luminance processing section may each use, as the latest calculated velocity, the difference between the latest calculated distance and the distance calculated in the past both corresponding to the respective light receiving element.

### First Modification of the First Embodiment

The filter processing section 1034 in this modification performs filter processing of calculating and smoothing, by the high luminance processing section and the medium luminance processing section, a weighted average of the distances calculated by the calculation section 1032 in correspondence with each light receiving element.

In more detail, each of the high luminance processing sections in this modification, when instructed by the setting section 410 to perform the filter processing in accordance with the high luminance value, reads the latest calculated distance and all the distances calculated in the past by the calculation section 1032 throughout a predefined time period in correspondence with the light receiving element corresponding to the respective high luminance processing section, from the storage section 1035 as distances which are targets of weighted averaging. Each of the high luminance processing sections in this modification, at the same time as reading the distances which are the targets of weighted averaging, reads, from the storage section 1035, weighting constants predefined such that the latest calculated distance having a relatively high accuracy is reflected on the latest smoothed distance at a relatively high degree as in the first embodiment.

The “weighting constants predefined such that the latest calculated distance having a relatively high accuracy is reflected on the latest smoothed distance at a relatively high degree” are weighting constants to be multiplied by the distances which are the targets of weighted averaging; more specifically, weighting constants which gradually decrease from the largest weighting constant to be multiplied by the latest calculated distance to the smallest weighting constant to be multiplied by the distance calculated at the oldest time in the past.

Upon reading the distances which are the targets of weighted averaging and the weighting constants, each of the high luminance processing sections in this modification operates weighted averaging by multiplying each distance as the target of weighted averaging by the corresponding weighting constant and then adding all the multiplication results. Upon operating the weighted averaging of the distances which are the targets of weighted averaging, each of the high luminance processing sections stores the distance obtained by the weighted averaging on the storage section 1035 in correspondence with the light receiving element corresponding to the respective high luminance processing section.

The weighting constants read by each high luminance processing section from the storage section 1035 do not need to gradually decrease from the largest weighting constant to be multiplied by the latest calculated distance to the smallest weighting constant to be multiplied by the distance calculated at the oldest time in the past. As long as the latest calculated distance is reflected on the distance obtained by the weighted averaging at a relatively high degree, any type of weighting constants are usable.

Each of the medium luminance processing sections in this modification, when instructed by the setting section 410 to perform the filter processing in accordance with the medium luminance value, reads the latest calculated distance and all the distances calculated in the past by the calculation section 1032 throughout a predefined time period in correspondence with the light receiving element corresponding to the respective medium luminance processing section, from the storage section 1035 as distances which are targets of weighted averaging. Each of the medium luminance processing sections in this modification, at the same time as reading the distances which are the targets of weighted averaging, reads, from the storage section 1035, weighting constants predefined such that the latest calculated distance having a relatively low accuracy is reflected on the latest smoothed distance at a relatively low degree as in the first embodiment.

The “weighting constants predefined such that the latest calculated distance having a relatively low accuracy is reflected on the latest smoothed distance at a relatively low degree” are weighting constants to be multiplied by the distances which are the targets of weighted averaging; more specifically, weighting constants which gradually increase from the smallest weighting constant to be multiplied by the latest calculated distance to the largest weighting constant to be multiplied by the distance calculated at the oldest time in the past.

Upon reading the distances which are the targets of weighted averaging and the weighting constants, each of the medium luminance processing sections in this modification operates weighted averaging by multiplying each distance as the target of weighted averaging by the corresponding weighting constant and then adding all the multiplication results. Upon operating the weighted averaging of the distances which are the targets of weighted averaging, each of the medium luminance processing sections stores the distance obtained by the weighted averaging on the storage section 1035 in correspondence with the light receiving element corresponding to the respective medium luminance processing section.

The weighting constants read by each low luminance processing section from the storage section 1035 do not need to gradually increase from the smallest weighting constant to be multiplied by the latest calculated distance to the largest weighting constant to be multiplied by the distance calculated at the oldest time in the past. As long as the latest calculated distance is reflected on the distance obtained by the weighted averaging at a relatively low degree, any type of weighting constants are usable.

In this manner, as in the first embodiment, the distance detection apparatus in the first modification of the first embodiment can also prevent the accuracy of a distance to be detected from decreasing in accordance with the signal-to-noise ratio of the accumulated electric charge.

In this modification, a data table representing predefined weighting constants in correspondence with each of the high luminance value and the medium luminance value may be stored on the storage section 1035 in advance. In this case, the high luminance processing section and the medium luminance processing section, when being instructed by the setting section 410 to perform the filter processing as the high luminance processing section and the medium luminance processing section respectively, read appropriate weighting constants from the data table stored on the storage section 1035 and perform the filter processing.

In this modification, the high luminance processing section and the medium luminance processing section, after being instructed by the setting section 410 to perform the filter processing in accordance with the high luminance value and the medium luminance value respectively, read the weighting constants in accordance with the respective filter processing from the storage section 1035. Alternatively, in this modification, the setting section 410, when issuing an instruction to perform the filter processing in accordance with the high luminance value and the medium luminance value respectively, may read the weighting constants in accordance with the respective filter processing from the storage section 1035 and allow the high luminance processing section and the medium luminance processing section to acquire the weighting constants.

In this modification, the above-described weighting constant is the filter coefficient.

In this modification, the functional structural elements except for those described above make the same operations as those described in the first embodiment.

### Second Modification of the First Embodiment

The filter processing section 1034 in this modification performs filter processing of calculating and smoothing, by the high luminance processing section and the medium luminance processing section, a moving average of the distances calculated by the calculation section 1032 in correspondence with each light receiving element.

In more detail, each of the high luminance processing sections in this modification, when instructed by the setting section 410 to perform the filter processing in accordance with the high luminance value, first reads a time period predefined to be relatively short in accordance with the filter processing of calculating the moving average performed by the respective high luminance processing section (hereinafter, this time period will be referred to as the “moving averaging period”) from the storage section 1035. Upon reading the moving averaging period, each of the high luminance processing sections further reads the latest calculated distance and all the distances calculated in the past by the calculation section 1032 throughout the read moving averaging period in correspondence with the light receiving element corresponding to the respective high luminance processing section, from the storage section 1035 as distances which are targets of moving averaging.

Upon reading the distances which are the targets of moving averaging, each of the high luminance processing sections in this modification calculates and smoothes an average of the distances which are the targets of moving averaging. Upon calculating the smoothed distance, each of the high luminance processing sections in this modification stores the smoothed distance on the storage section 1035 in correspondence with the light receiving element corresponding to the respective high luminance processing section.

The high luminance processing section in this modification smoothes the distance calculated throughout the relatively short moving averaging period. Therefore, as in the first embodiment, the latest calculated distance calculated at a relatively high accuracy is reflected on the latest smoothed distance at a relatively high degree.

Each of the medium luminance processing sections in this modification, when instructed by the setting section 410 to perform the filter processing in accordance with the medium luminance value, first reads a time period predefined to be relatively long in accordance with the filter processing of calculating the moving average performed by the respective medium luminance processing section from the storage section 1035. Upon reading the moving averaging period, each of the medium luminance processing sections further reads the latest calculated distance and all the distances calculated in the past by the calculation section 1032 throughout the read moving averaging period in correspondence with the light receiving element corresponding to the respective medium luminance processing section, from the storage section 1035 as distances which are targets of moving averaging.

Upon reading the distances which are the targets of moving averaging, each of the medium luminance processing sections in this modification calculates and smoothes an average of the distances which are the targets of moving averaging. Upon calculating the smoothed distance, each of the medium luminance processing sections in this modification stores the smoothed distance on the storage section 1035 in correspondence with the light receiving element corresponding to the respective medium luminance processing section.

The medium luminance processing section in this modification smoothes the distance calculated throughout the relatively long moving averaging period. Therefore, as in the first embodiment, the latest calculated distance calculated at a relatively low accuracy is reflected on the latest smoothed distance at a relatively low degree.

In this manner, as in the first embodiment, the distance detection apparatus in the second modification of the first embodiment can also prevent the accuracy of a distance to be detected from decreasing in accordance with the signal-to-noise ratio of the accumulated electric charge.

In this modification, a data table representing the predefined moving averaging period in correspondence with each of the high luminance value and the medium luminance value may be stored on the storage section 1035 in advance. In this case, the high luminance processing section and the medium luminance processing section, when being instructed by the setting section 410 to perform the filter processing as the high luminance processing section and the medium luminance processing section respectively, read an appropriate moving averaging period from the data table stored on the storage section 1035 and perform the filter processing.

In this modification, the high luminance processing section and the medium luminance processing section, after being instructed by the setting section 410 to perform the filter processing in accordance with the high luminance value and the medium luminance value respectively, read the moving averaging period in accordance with the respective filter processing from the storage section 1035. Alternatively, in this embodiment, the setting section 410, when issuing an instruction to perform the filter processing in accordance with the high luminance value and the medium luminance value respectively, may read the moving averaging period in accordance with the respective filter processing from the storage section 1035 and allow the high luminance processing section and the medium luminance processing section to acquire the moving averaging period.

In this modification, the functional structural elements except for those described above make the same operations as those described in the first embodiment.

### Third Modification of the First Embodiment

In this modification, the setting section 410 specifies a light receiving element based on a distance dispersion value calculated in correspondence with each light receiving element. FIG. 4 is a functional block diagram showing more detailed functional structural elements of the control and operation section 103 in the third modification of the first embodiment. As compared with the control and operation section 103 in the first embodiment, the control and operation section 103 in this modification further includes a distance dispersion calculation section 1037. Among the functional structural elements of the distance detection apparatus 1 in this modification, the functional structural elements except for those described later make the same operations as those described in the first embodiment, and the descriptions thereof will be omitted.

After the distance calculated in correspondence with each light receiving element is stored on the storage section 1035, the distance dispersion calculation section 1037 in this modification reads the latest calculated distance and all the distances calculated in the past throughout a predefined time period (hereinafter, referred to as the “dispersion calculation period”) in correspondence with each light receiving element from the storage section 1035.

Upon reading the distances calculated throughout the dispersion calculation period in correspondence with each light receiving element from the storage section 1035, the distance dispersion calculation section 1037 calculates a dispersion value of the distances calculated throughout the dispersion calculation period in correspondence with each light receiving element. Upon calculating the distance dispersion value corresponding to each light receiving element, the distance dispersion calculation section 1037 stores the calculated distance dispersion value on the storage section 1035 in correspondence with each light receiving element.

When the distance dispersion calculation section 1037 stores the distance dispersion value on the storage section 1035 in correspondence with each light receiving element, the setting section 410 in this modification specifies a light receiving element corresponding to a distance dispersion value, among the stored dispersion values, which is equal to or lower than a predefined third threshold value.

The calculated distances corresponding to the light receiving element corresponding to the distance dispersion value which is equal to or lower than the third threshold value have a relatively small variance because the dispersion value is equal to or lower than the third threshold value, and are considered to be calculated at a relatively high accuracy throughout the dispersion calculation period. Namely, in this modification, the distances corresponding to the light receiving element corresponding the distance dispersion value which is equal to or lower than the third threshold value correspond to the distance calculated in correspondence with the light receiving element corresponding to the high luminance value described in the first embodiment. Therefore, the setting section 410 instructs a processing section, among the first processing section 401 through the n'th processing section 40n, corresponding to the light receiving element corresponding to the distance dispersion value which is equal to or lower than the third threshold value to perform the filter processing in accordance with the high luminance value.

When the distance dispersion calculation section 1037 stores the distance dispersion value on the storage section 1035 in correspondence with each light receiving element, the setting section 410 in this modification also specifies a light receiving element corresponding to a distance dispersion value, among the stored dispersion values, which exceeds the third threshold value and is equal to or lower than a fourth threshold value predefined to be larger than the third threshold value.

The calculated distances corresponding to the light receiving element corresponding to the distance dispersion value which exceeds the third threshold value and is equal to or lower than the fourth threshold value have a relatively large variance because the dispersion value exceeds the third threshold value and is equal to or lower than the fourth threshold value, and are considered to be calculated at a relatively low accuracy throughout the dispersion calculation period. Namely, in this modification, the distances corresponding to the light receiving element corresponding the distance dispersion value which exceeds the third threshold value and is equal to or lower than the fourth threshold value correspond to the distance calculated in correspondence with the light receiving element corresponding to the medium luminance value described in the first embodiment. Therefore, the setting section 410 instructs a processing section, among the first processing section 401 through the n'th processing section 40n, corresponding to the light receiving element corresponding to the distance dispersion value which exceeds the third threshold value and is equal to or lower than the fourth threshold value to perform the filter processing in accordance with the medium luminance value.

When the distance dispersion calculation section 1037 stores the distance dispersion value on the storage section 1035 in correspondence with each light receiving element, the setting section 410 in this modification also specifies a light receiving element corresponding to a distance dispersion value, among the stored dispersion values, which exceeds the fourth threshold value.

The calculated distances corresponding to the light receiving element corresponding to the distance dispersion value which exceeds the fourth threshold value have an excessively large variance because the dispersion value exceeds the fourth threshold value, and are considered to be calculated at an excessively low accuracy throughout the dispersion calculation period. Namely, in this modification, the distances corresponding to the light receiving element corresponding the distance dispersion value which exceeds the fourth threshold value correspond to the distance calculated in correspondence with the light receiving element corresponding to the low luminance value described in the first embodiment. Therefore, the setting section 410 instructs a processing section, among the first processing section 401 through the n'th processing section 40n, corresponding to the light receiving element corresponding to the distance dispersion value which exceeds the fourth threshold value to perform the filter processing in accordance with the low luminance value.

In this manner, the distance detection apparatus 1 in this modification can allow each of the first processing section 401 through the n'th processing section 40n to perform the filter processing in accordance with the accuracy of the latest calculated distance determined based on the distance dispersion value.

The distance detection apparatus 1 in this modification may use a luminance value dispersion value instead of the distance dispersion value. As in the case of using the distance dispersion value, the setting section 410 may instruct each of the first processing section 401 through the n'th processing section 40n to perform the respective type of filter processing (filter processing in accordance with the high luminance value, the medium luminance value or the low luminance value).

### Fourth Modification of the First Embodiment)

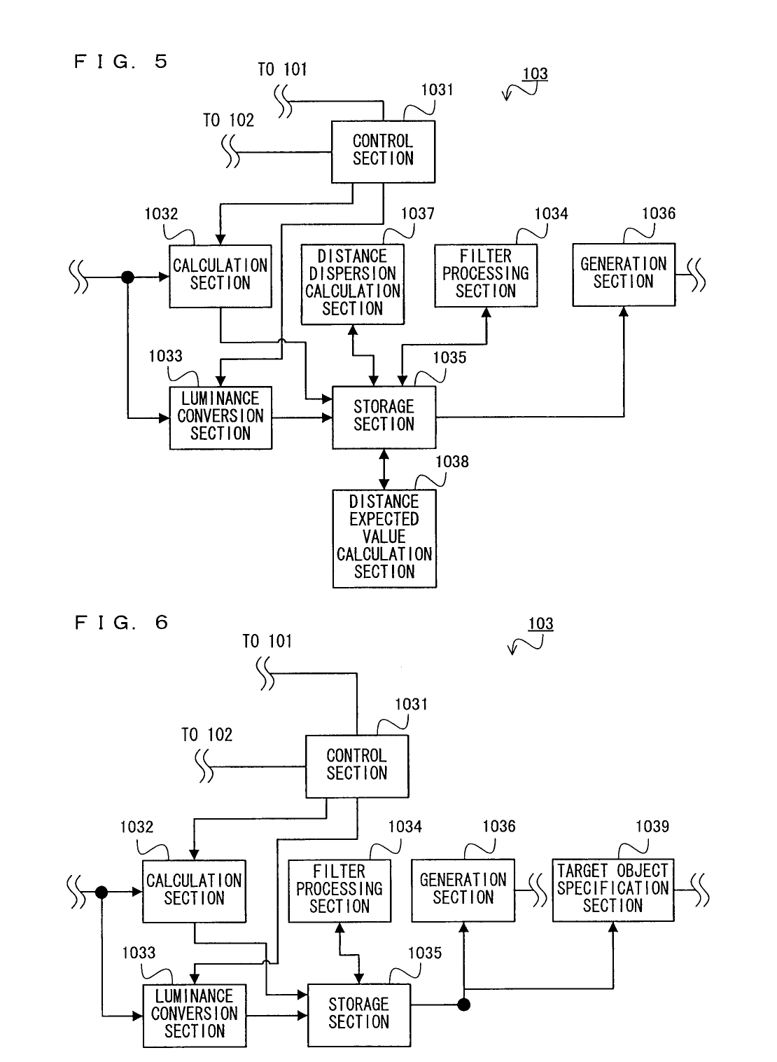

The filter processing section 1034 in this modification performs filter processing based on a distance dispersion value calculated in correspondence with each light receiving element and a distance expected value calculated in correspondence with each light receiving element. FIG. 5 is a functional block diagram showing more detailed functional structural elements of the control and operation section 103 in the fourth modification of the first embodiment. As compared with the control and operation section 103 in the third modification of the first embodiment, the control and operation section 103 in this modification further includes a distance expected value calculation section 1038. The functional structural elements of the filter processing section 1034 in this modification are also different from those of the filter processing section 1034 in the third modification of the first embodiment. Among the functional structural elements of the distance detection apparatus 1 in this modification, the functional structural elements except for those described later make the same operations as those described in the third modification of the first embodiment, and the descriptions thereof will be omitted.

After the distance calculated in correspondence with each light receiving element is stored on the storage section 1035, the distance expected value calculation section 1038 in this modification reads the latest calculated distance and all the distances calculated in the past throughout a predefined time period (hereinafter, referred to as the “expected value calculation period”) in correspondence with each light receiving element from the storage section 1035.

Upon reading the distances calculated throughout the expected value calculation period in correspondence with each light receiving element from the storage section 1035, the expected value calculation section 1038 calculates an expected value of the distances calculated throughout the expected value calculation period in correspondence with each light receiving element. Upon calculating the distance expected value corresponding to each light receiving element, the expected value calculation section 1038 stores the calculated distance expected value on the storage section 1035 in correspondence with each light receiving element.

When the distance dispersion calculation section 1037 stores the distance dispersion value on the storage section 1035 in correspondence with each light receiving element and the distance expected value calculation section 1038 stores the distance expected value on the storage section 1035 in correspondence with each light receiving element, the setting section 410 in this modification specifies a light receiving element regarding which the distance dispersion value stored on the storage section 1035 is equal to or lower than the third threshold value described in the third modification of the first embodiment and regarding which a difference between the latest calculated distance and the expected value both stored on the storage section 1035 is equal to or higher than a predefined fifth threshold value.

A light receiving element regarding which the distance dispersion value is equal to or lower than the third threshold value and regarding which a difference between the latest calculated distance and the expected value is equal to or higher than the fifth threshold value corresponds to distances which have a relatively small distance dispersion value as described in the third modification of the first embodiment and are calculated at a relatively high accuracy throughout the dispersion calculation period. The accuracy of the latest calculated distance corresponding to such a light receiving element is considered to be relatively high. A light receiving element regarding which a difference between the latest calculated distance and the expected value is equal to or higher than the fifth threshold value, although the latest calculated distance is calculated at a relatively high accuracy, is considered to be a light receiving element which has received reflected light reflected at a reflection point at which the distance from the light receiving element was rapidly changed after the distance was calculated the immediately previous time. One conceivable reason why the distance from the light receiving element to the reflection point is rapidly changed is that a target object suddenly invades into the measurement zone of the distance detection apparatus 1 according to the present invention in a direction parallel to the substrate having the light receiving elements in a lattice. The measurement zone of the distance detection apparatus 1 is formed of all the light receiving zones in each of which the corresponding light receiving element receives the reflected light.

It is preferable that the latest calculated distance to the target object which has suddenly invaded is detected as it is or detected as a distance close to the latest calculated distance. The reason for this is that in this way, an apparatus connected on the later stage to the distance detection apparatus 1 according to the present invention can immediately perform correct processing on the target which has suddenly invaded.

Therefore, the setting section 410 in this modification instructs a processing section, among the first processing section 401 through the n'th processing section 40n, corresponding to the light receiving element regarding which a distance dispersion value is equal to or lower than the third threshold value and regarding which a difference between the latest calculated distance and the expected value is equal to or higher than the fifth threshold value to perform the filter processing of allowing the latest calculated distance to pass as the latest smoothed distance.

In this manner, when, for example, a target object suddenly invades into the above-described measurement zone, the distance detection apparatus 1 in this modification can calculate a distance preferable for an apparatus to be connected on the later stage by filter processing.

### Second Embodiment

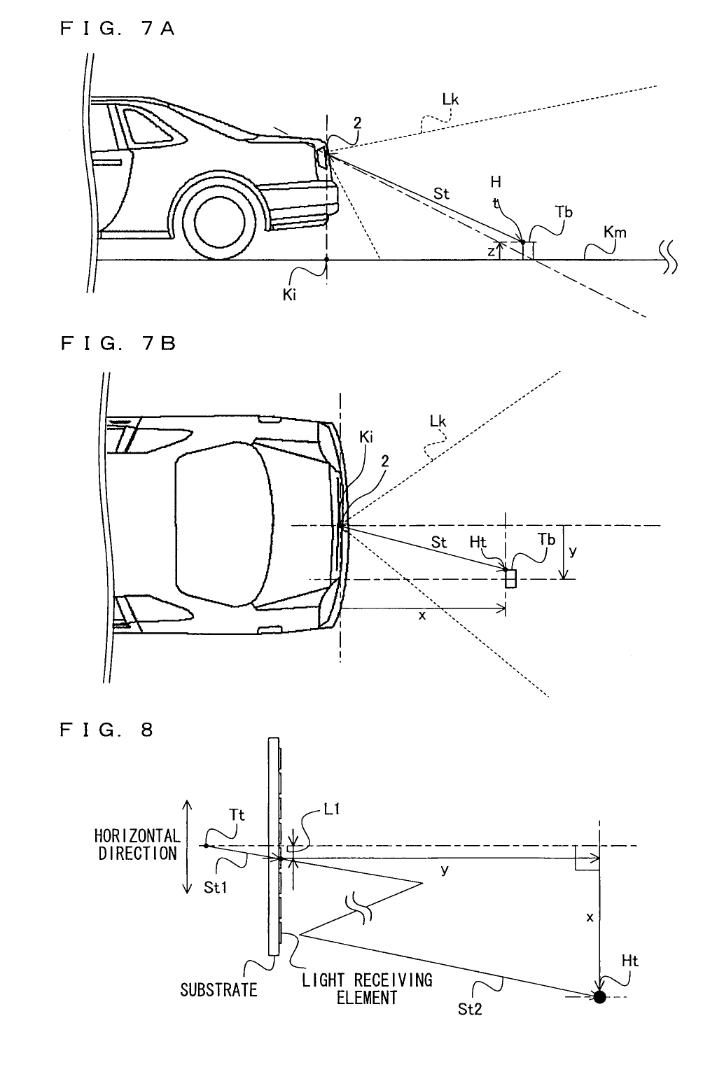

FIG. 7 is a functional block diagram showing more detailed functional structural elements of the control and operation section 103 of a distance detection apparatus 2 in a second embodiment. As compared with the control and operation section 103 in the first embodiment, the control and operation section 103 in this modification further includes a target object specification section 1039. Identical functional structural elements as those of the distance detection apparatus 1 in the first embodiment will bear identical reference numerals thereto and descriptions thereof will be omitted.

The distance detection apparatus 2 in this embodiment will be described, for example, as being mounted on a movable body such as a vehicle (hereinafter, referred to as a “self-vehicle”). FIG. 7A and FIG. 7B show an example of a measurement zone in the case where the distance detection apparatus 2 in this embodiment is mounted on a self-vehicle. As shown in FIG. 7A and FIG. 7B, the radiation section 101 of the distance detection apparatus 2 in this embodiment is attached in the vicinity of a number plate in a rear part of the self-vehicle such that infrared light is radiated to a target object which is present on a road surface rear to the self-vehicle. The conversion section 102 of the distance detection apparatus 2 in this embodiment is, for example, attached in the vicinity of the number plate in the rear part of the self-vehicle such that the light receiving elements described in the first embodiment receive the infrared light radiated from the radiation section 101 and then reflected by the target object. The distance to the reflection point, the reflected light from which can be received by the light receiving elements of the conversion section 102 attached to the number plate in the rear part of the self-vehicle is the measurement zone of the distance detection apparatus 2 in this embodiment. The reflected light is from the infrared light radiated from the radiation section 101. The target object Tb shown in FIG. 7A and FIG. 7B is one example of a target object which may be present in the measurement zone of the distance detection apparatus 2 in this embodiment. One or more target objects of various shapes, sizes and the like may be present in the measurement zone of the distance detection apparatus 2 in this embodiment. The conversion section 102 of the distance detection apparatus 2 in this embodiment may be attached in the vicinity of a side mirror, a front emblem or the like instead of in the vicinity of the number plate in the rear part of the self-vehicle.

The reflection point Ht shown in FIG. 7A and FIG. 7B is one example of a reflection point at which the light received by one light receiving element of the conversion section 102 was reflected, and the distance St is one example of a distance detectable by the distance detection apparatus 2 in this embodiment in correspondence with the one light receiving element. In the distance detection apparatus 2 in this embodiment, the reflected light reflected at each of the reflection points present on a surface of the target object which is present in the measurement zone is received by the corresponding light receiving element of the conversion section 102. The light receiving elements in the conversion section 102 provided in the distance detection apparatus 2 in this embodiment also receive the reflected light reflected at reflection points on the road surface on which the self-vehicle is running. As described in the first embodiment, the reflected light received by each light receiving element of the conversion section 102 is converted into an electric charge, a distance is calculated by the calculation section 1032 in correspondence with the respective light receiving element, and information representing the distance, which has been filter-processed by the filter processing section 1034, in correspondence with the respective light receiving element is generated by the generation section 1036. In the distance detection apparatus 2 in this embodiment, each time the electric charge amount converted from the reflected light received by each light receiving element of the conversion section 102 is detected by the calculation section 1032 and the luminance conversion section 1033, distance information is generated by the generation section 1036.

The target object specification section 1039 in this embodiment will be described. When the distance information generated by the generation section 1036 is stored on the storage section 1035, the target object specification section 1039 reads the stored distance information from the storage section 1035. Upon reading the distance information from the storage section 1035, the target object specification section 1039 converts the distance represented by the distance information in correspondence with each light receiving element into a three-dimensional position coordinate with respect to the position at which a substrate having the light receiving elements of the conversion section 102 is attached to the self-vehicle. The conversion is performed in correspondence with the respective light receiving element and based on the angle at which the substrate is attached to the self-vehicle (pitch angle, yaw angle, and roll angle).

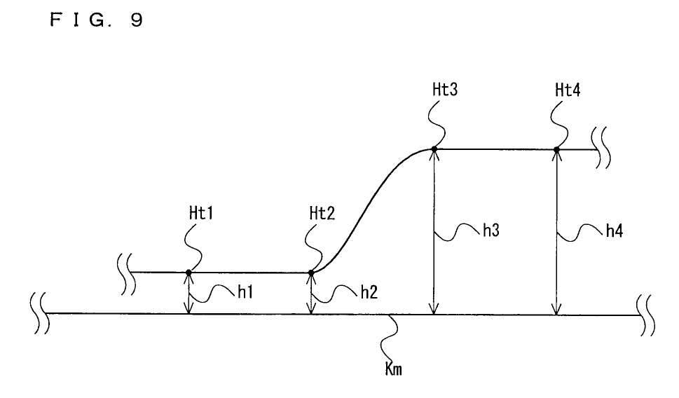

In more detail, for converting the distance represented by the distance information read from the storage section 1035 in correspondence with each light receiving element into a three-dimensional position coordinate, the target object specification section 1039 uses the position of the respective light receiving element with respect to the conversion section 102. FIG. 9 shows a technique by which the target object specification section 1039 converts the distance represented by the distance information in correspondence with each light receiving element into a three-dimensional position coordinate using the position of the respective light receiving element with respect to the conversion section 102. FIG. 9 is a plan view, as seen in the vertical direction, of the positional relationship between the light receiving elements arranged in a lattice on a flat substrate and the reflection point Ht at which light is reflected toward one of the light receiving elements.

As is clear from FIG. 9, when a perpendicular line is drawn from one light receiving element and the reflection point Ht at which the light is reflected toward the one light receiving element to a line passing the center of the substrate in a perpendicular direction, two similar right-angled triangles can be drawn. The positions of the light receiving elements on the substrate are known. Therefore, the length of each side of the right-angled triangle including the one light receiving element and the perpendicular line drawn from the one light receiving element to the line passing the center of the substrate in a perpendicular direction is known. Accordingly, as shown in FIG. 9, the target object specification section 1039 can calculate the x coordinate and the y coordinate of the reflection point Ht based on the ratio between the length St1 of the hypotenuse of the right-angled triangle including the position of the one light receiving element and the distance St2 from the one light receiving element to the reflection point Ht at which light is reflected toward the one light receiving element. The length St1 and the distance St2 are each a length as seen in the vertical direction.

Similarly, when the positional relationship between the light receiving elements arranged in a lattice on a flat substrate and the reflection point Ht at which light is reflected toward one of the light receiving elements is seen in a horizontal direction from the side, two right-angled triangles can be drawn. The positions of the light receiving elements on the substrate are known. Therefore, the length of each side of the right-angled triangle including the one light receiving element and a perpendicular line drawn from the one light receiving element to the line passing the center of the substrate in a perpendicular direction is known. Accordingly, the target object specification section 1039 can calculate the z coordinate of the reflection point Ht based on the ratio between the length of the hypotenuse of the right-angled triangle including the position of the one light receiving element and the distance from the one light receiving element to the reflection point Ht at which light is reflected toward the one light receiving element. The length and the distance are each a length as seen in the horizontal direction.

According to the technique described above with reference to FIG. 9, by which the distances represented by the distance information are each converted into a three-dimensional position coordinate, the apexes Tt of the similar triangles corresponding to each light receiving element as shown in FIG. 9 as an example do not match each other precisely, but the difference between the positions of the apexes Tt corresponding to each light receiving element is sufficiently small and so negligible with respect to the distance represented by the distance information calculated in correspondence with each light receiving element. Therefore, even if the position coordinate converted using the technique described with reference to FIG. 9 is found with respect to the attaching position of the substrate to the self-vehicle, the accuracy of the converted position coordinate is not decreased.

Upon converting the distance represented by the distance information in correspondence with each light receiving element into a three-dimensional position coordinate with respect to the attaching position of the substrate to the self-vehicle in correspondence with the respective light receiving element using the technique described with reference to FIG. 9, the target object specification section 1039 further converts the converted position coordinate into a position coordinate with respect to a reference position Ki shown in FIG. 7A and FIG. 7B.

The reference position Ki shown in FIG. 7A and FIG. 7B is a position on a reference plane Km which is right below, in the vertical direction, the attaching position of the substrate having the light receiving elements of the conversion section 102 to the self-vehicle. The reference plane Km is successively calculated by the target object specification section 1039 based on, for example, the inclination of the self-vehicle detected by a detection section (sensor) not shown) as a plane parallel to the bottom surface of the self-vehicle. The attaching position of the substrate having the light receiving elements of the conversion section 102 to the self-vehicle is known, and the reference plane Km is calculated by the target object specification section 1039. Therefore, the reference position Ki can also be calculated by the target object specification section 1039.

Upon converting the distance represented by the distance information read from the storage section 1035 into a three-dimensional position coordinate with respect to the reference position Ki in correspondence with each light receiving element, the target object specification section 1039 stores the converted position coordinate on the storage section 1035 in correspondence with the respective light receiving element.

Upon storing the position coordinate corresponding to each light receiving element on the storage section 1035, the target object specification section 1039 specifies, from the reflection points present at the converted position coordinates, a reflection point which is present on a surface of a vehicle, a passenger, an obstacle or the like present on the road surface as a target object reflection point based on the respective position coordinate.

FIG. 9 shows an example of the target object reflection points which can be specified by the target object specification section 1039 based on the respective converted position coordinates. FIG. 9 shows four reflection points Ht1 through Ht4 as examples of the reflection points represented by the converted position coordinates. In FIG. 9, the reflection points Ht1 and Ht2 are at an equal height from the reference plane Km described above. The difference (inclination) between the heights of the reflection points Ht2 and Ht3 from the reference plane Km exceeds a predefined first threshold value. The reflection points Ht3 and Ht4 are at an equal height from the reference plane Km.

Based on the converted position coordinates as shown in FIG. 9, the target object specification section 1039 specifies reflection points at adjacent position coordinates at the heights from the reference plane Km which are different by a value equal to or less than the first threshold value (in the example shown in FIG. 9, the reflection points Ht1 and Ht2, and the reflection points Ht3 and Ht4) as the reflection points on the road surface. Also based on the converted position coordinates, the target object specification section 1039 specifies reflection points at adjacent position coordinates at the heights from the reference plane Km which are different by a value exceeding the first threshold value (in the example shown in FIG. 9, the reflection points Ht2 and Ht3) as the reflection points on a target object other than the road surface (hereinafter, such a reflection point will be referred to as the “target object reflection point”). In this embodiment, the reflection points present at the border between the road surface and the target object (in the example shown in FIG. 9, the reflection points Ht2 and Ht3) are specified as the target object reflection points.

Upon specifying the target object reflection points, the target object specification section 1039 recognizes, among the position coordinates of the specified target object reflection points, target object reflection points at adjacent position coordinates away from each other by a distance which is equal to or shorter than a predefined second threshold value as the target object reflection points on a surface of one target object and classifies these target object reflection points in the same group. Upon grouping all the target object reflection points, the target object specification section 1039 stores the position coordinates of the target object reflection points classified into the same group on the storage section 1035 in correspondence with each of all the groups. The target object specification section 1039 also stores the position coordinates of the reflection points on the road surface on the storage section 1035.

The above is a description of the distance detection apparatus 2 in this embodiment. According to the distance detection apparatus 2 in this embodiment, a distance can be detected without excessively decreasing the accuracy regardless of the signal-to-noise ratio of the accumulated electric charge, and a target object present in the measurement zone can be specified.

As described in the first embodiment, in this embodiment also, the high luminance processing section and the medium luminance processing section may each perform the Kalman filter processing on the latest calculated velocity to calculate the latest smoothed acceleration, as well as performing the Kalman filter processing on the latest calculated distance to calculate the latest smoothed distance. In this case, the setting section 410 in this embodiment may instruct a processing section, among the first processing section 401 through the n'th processing section 40n, corresponding to the light receiving element corresponding the position coordinate stored by the target object specification section 1039 on the storage section 1035 in correspondence with each group to calculate the latest smoothed distance and the latest smoothed velocity. The setting section 410 may instruct a processing section corresponding to the light receiving element corresponding to the position coordinate of a reflection point on the road surface stored by the target object specification section 1039 on the storage section 1035 to calculate only the latest smoothed distance.

### First Modification of the Second Embodiment

After the target objects are specified by the target object specification section 1039 in the second embodiment, the filter processing section 1034 in this modification determines a filter coefficient for each specified target object. In more detail, after the target objects are specified by the target object specification section 1039, when the latest calculated distance calculated by the calculation section 1032 in correspondence with each light receiving element and the luminance value converted by the luminance conversion section 1033 in correspondence with each light receiving element are stored on the storage section 1035, the setting section 410 in this modification specifies, from the position coordinates stored by the target object specification section 1039 on the storage section 1035 in correspondence with each group, the closest position coordinate for each group. Upon specifying the closest position coordinate for each group, the setting section 410 in this modification specifies the light receiving element corresponding to the closest position coordinate for each group.

Then, the setting section 410 in this embodiment specifies, from the light receiving elements corresponding to the closest position coordinates for the respective groups, a light receiving element corresponding to each of the high luminance value, the medium luminance value and the low luminance value described in the first embodiment in the same manner as in the first embodiment. Upon specifying the light receiving element corresponding to each of the high luminance value, the medium luminance value and the low luminance value from the light receiving elements corresponding to the closest position coordinates for the respective groups, the setting section 410 in this modification specifies, for each group, the light receiving elements corresponding to the position coordinates classified in the same group as the position coordinate corresponding to each specified light receiving element. More specifically, upon specifying the light receiving element corresponding to the high luminance value, the setting section 410 in this modification specifies each of the light receiving elements corresponding to the position coordinates classified in the same group as the position coordinate corresponding to the specified light receiving element as a high luminance light receiving element. Upon specifying the light receiving element corresponding to the medium luminance value, the setting section 410 in this modification specifies each of the light receiving elements corresponding to the position coordinates classified in the same group as the position coordinate corresponding to the specified light receiving element as a medium luminance light receiving element. Upon specifying the light receiving element corresponding to the low luminance value, the setting section 410 in this modification specifies each of the light receiving elements corresponding to the position coordinates classified in the same group as the position coordinate corresponding to the specified light receiving element as a low luminance light receiving element.

Upon specifying the high luminance light receiving elements, the medium luminance light receiving elements and the low luminance light receiving elements, the setting section 410 in this modification instructs a processing section, among the first processing section 401 through the n'th processing section 40n, corresponding to each light receiving element to perform the filter processing in accordance with the respective luminance value. More specifically, the setting section 410 in this modification instructs the processing section, among the first processing section 401 through the n'th processing section 40n, corresponding to the high luminance light receiving element to perform the filter processing in accordance with the high luminance value. The setting section 410 in this modification instructs the processing section, among the first processing section 401 through the n'th processing section 40n, corresponding to the medium luminance light receiving element to perform the filter processing in accordance with the medium luminance value. The setting section 410 in this modification instructs the processing section, among the first processing section 401 through the n'th processing section 40n, corresponding to the low luminance light receiving element to perform the filter processing in accordance with the low luminance value.

When instructed by the setting section 410, the first processing section 401 through the n'th processing section 40n each perform the filter processing as a high luminance processing section, a medium luminance processing section or a low luminance processing section as in the first embodiment.

The above is a description of the distance detection apparatus 2 in this modification. According to this modification, the setting section 410 can determine, from the first processing section 401 through the n'th processing section 40n, the processing section which is to perform the filter processing as the high luminance processing section, the medium luminance processing section or the luminance processing section and can issue such an instruction at a lower processing load without comparing all the luminance values stored on the storage section 1035 in correspondence with each light receiving element against the thresholds.

The functional structural elements, i.e., the control section 1031, the calculation section 1032, the luminance conversion section 1033, the filter processing section 1034, the generation section 1036, the distance dispersion calculation section 1037, and the target object specification section 1039 described in any of the above embodiments or any of the above modifications are each typically a control section formed of an integrated circuit such as a CPU (Central Processing Unit), an LSI (Large Scale Integration), a microcomputer or the like. Each such control section may read a predefined program from the storage section 1035 and interpret and executes the program, and thus act as a respective functional structural element appropriately.

In this embodiment, in order to alleviate the processing load on the filter processing section 1034, the light receiving elements which are considered when the filter processing section 1034 performs filter processing on the latest calculated distance or the latest calculated velocity may be thinned out. More specifically, the filter processing on the latest calculated distance or the latest calculated velocity may be performed at an interval of a predefined number of light receiving elements, for example, every two light receiving elements or the like, among the light receiving elements arranged in a lattice in the conversion section 102. Alternatively, the filter processing on the latest calculated distance or the latest calculated velocity may be performed on, for example, one light receiving element in each block of 2 rows×2 columns, among the light receiving elements arranged in a lattice in the conversion section 102. Furthermore, the degree of thinning out the light receiving elements which are considered when the filter processing section 1034 performs filter processing on the latest calculated distance or the latest calculated velocity may be varied; for example, made relatively low when the magnitude of the average value of the latest calculated distances calculated in correspondence with each light receiving element is relatively large and may be made high when the magnitude of such an average value is relatively small.

All the embodiments and all the modifications described above may be combined in any way. Various combinations are conceivable. For example, based on the result of comparing each of the luminance value, the distance dispersion value and the distance expected value against the threshold values, the setting section 410 may determine the processing section, among the first processing section 401 through the n'th processing section 40n, which is to act as the high luminance processing section, the medium luminance processing section or the low luminance processing section, and thus can easily determine, at a high accuracy, the processing section in correspondence with the luminance value, for example, the high luminance processing section, the medium luminance processing section or the low luminance processing section.

### INDUSTRIAL APPLICABILITY

According to the present invention, the accuracy of a distance to be detected is prevented from decreasing due to a signal-to-noise ratio of an accumulated electric charge. The present invention is applicable for, for example, a distance detection apparatus mountable on a movable body such as a vehicle.

1. A distance detection apparatus, comprising:
a radiation section for radiating light;
a conversion section for converting light radiated and then reflected at a target object into an electric charge by each of light receiving elements arranged in a lattice;
a luminance conversion section for converting the electric charge converted by each of the light receiving elements into a luminance value corresponding to the respective light receiving element;
a calculation section for calculating a distance corresponding to each of the light receiving elements based on the electric charge converted by the respective light receiving element;
a filter processing section for performing filter processing on the distance corresponding to each of the light receiving element based on the luminance value corresponding to the respective light receiving element; and
a generation section for generating distance information representing the distance filter-processed by the filter processing section.

2. A distance detection apparatus according to claim 1, wherein the filter processing section performs the filter processing based on the luminance value corresponding to each of the light receiving elements, using the distance calculated in the past in correspondence with the respective light receiving element.

3. A distance detection apparatus according to claim 2, wherein the filter processing section includes:
a setting section for specifying the light receiving element corresponding to the luminance which is equal to or higher than a predefined threshold value among the light receiving elements corresponding to the luminance values converted by the luminance conversion section; and
a processing section for performing the filter processing such that the distance calculated in correspondence with the light receiving element specified by the setting section is reflected at a relatively high degree as compared with the distance calculated in the past in correspondence with the light receiving element.

4. A distance detection apparatus according to claim 2, wherein the filter processing section includes:
a setting section for specifying the light receiving element corresponding to the luminance which is lower than a predefined threshold value among the light receiving elements corresponding to the luminance values converted by the luminance conversion section; and
a processing section for performing the filter processing such that the distance calculated in correspondence with the light receiving element specified by the setting section is reflected at a relatively low degree as compared with the distance calculated in the past in correspondence with the light receiving element.

5. A distance detection apparatus according to claim 2, wherein the filter processing section includes:
a dispersion calculation section for calculating a dispersion value of the luminance values, corresponding to each of the light receiving elements, converted by the luminance conversion section throughout a predefined period;
a setting section for specifying a dispersion value of the luminance values which is equal to or lower than a predefined threshold value among the light receiving elements each corresponding to the dispersion value of the luminance values calculated by the dispersion calculation section; and
a processing section for performing the filter processing such that the distance calculated in correspondence with the light receiving element specified by the setting section is reflected at a relatively high degree as compared with the distance calculated in the past in correspondence with the light receiving element.

6. A distance detection apparatus according to claim 2, wherein the filter processing section includes:
a dispersion calculation section for calculating a dispersion value of the luminance values, corresponding to each of the light receiving elements, converted by the luminance conversion section throughout a predefined period;
a setting section for specifying a dispersion value of the luminance values which exceeds a predefined threshold value among the light receiving elements each corresponding to the dispersion value of the luminance values calculated by the dispersion calculation section; and
a processing section for performing the filter processing such that the distance calculated in correspondence with the light receiving element specified by the setting section is reflected at a relatively low degree as compared with the distance calculated in the past in correspondence with the light receiving element.

7. A distance detection method, comprising:
a radiation step of radiating light;
a conversion step of converting light radiated and then reflected at a target object into an electric charge by each of light receiving elements arranged in a lattice;
a luminance conversion step of converting the electric charge converted by each of the light receiving elements into a luminance value corresponding to the respective light receiving element;
a calculation step of calculating a distance corresponding to each of the light receiving elements based on the electric charge converted by the respective light receiving element;
a filter processing step of performing filter processing on the distance corresponding to each of the light receiving element based on the luminance value corresponding to the respective light receiving element; and
a generation step of generating distance information representing the distance filter-processed by the filter processing section.
